(19) United States
(12) Patent Application Publication
(10) Pub. No.: US 2019/0352214 A1
(43) Pub. Date: Nov. 21, 2019

(54) METHOD AND APPARATUS FOR SEPARATING GLASS SHEETS

(71) Applicant: CORNING INCORPORATED, CORNING, NY (US)

(72) Inventors: Andrew Peter Kittleson, Honeoye Falls, NY (US); Gautam Narendra Kudva, Horseheads, NY (US); Eric Lee Miller, Corning, NY (US); Calvibn Jay Winder, Cromwell, CT (US)

(73) Assignee: CORNING INCORPORATED, CORNING, NY (US)

(21) Appl. No.: 16/480,434

(22) PCT Filed: Jan. 26, 2018
(86) PCT No.: PCT/US2018/015365

§ 371 Date: Jul. 24, 2019

Related U.S. Application Data
(60) Provisional application No. 62/451,374, filed on Jan. 27, 2017.

(51) Int. Cl. C03B 33/037; C03B 33/033

(52) U.S. Cl. CPC C03B 33/037; C03B 33/033

(57) ABSTRACT

Methods and apparatus for separating a glass sheet are described. An apparatus and a method utilize a vent bar having a cushion that exerts a force on the glass sheet adjacent a vent line to break the glass into two pieces at the vent line. The edge of the glass sheet has excellent perpendicularity without subsequent grinding and/or polishing so that the glass sheet can be used as a light guide plate in a display.

### CROSS-REFERENCE TO RELATED APPLICATION

This application claims the benefit of priority under 35 U.S.C. § 119 of U.S. Provisional Application Ser. No. 62/451,374 filed on Jan. 27, 2017, the content of which is relied upon and incorporated herein by reference in its entirety.

### BACKGROUND

Thin glass sheets have found use in many optical, electronic or optoeletronic devices, such as liquid crystal displays (LCD), organic light-emitting diode (OLED) displays, solar cells, as semiconductor device substrates, color filter substrates, cover sheets for electronic device such as mobile phones and tablets, and the like. The thin glass sheets, having a thickness from several micrometers to several millimeters, may be fabricated by a number of methods, such as float process, fusion down-draw process (a method pioneered by Corning Incorporated, Corning, N.Y., U.S.A.), slot down-draw process, and the like.

In a specific example of a thin glass sheet, a light guide plate (LGP) is used in the back-light of edge-lit LCD displays to distribute light evenly over the display panel, to provide a crisp, brilliant image. Side lit back light units for such devices include an LGP that is usually made of high transmission plastic materials such as polymethylmethacrylate (PMMA). The trend toward thinner displays has been limited by challenges associated with using polymer light guide plates (LGPs). Although such plastic materials present excellent properties such as light transmission, these materials have relatively poor mechanical properties such as rigidity, coefficient of thermal expansion (CTE) and moisture absorption. In particular, polymer LGPs lack the dimensional stability required for ultra-slim displays. When a polymer LGP is subjected to heat and humidity, the LGP can warp and expand, compromising the opto-mechanical performance. The instability of polymer LGPs requires designers to add a wider bezel and thicker backlight with air gaps to compensate for this movement.

Glass sheets have been proposed as a LGP replacement solution for displays, but the glass sheets must have the appropriate attributes to achieve sufficient optical performance in terms of transmission, scattering and light coupling. Glass sheets for light guide plates must meet edge specifications such as perpendicularity, straightness and flatness. Glass sheets are cut to size to make LGPs by mechanical scoring, which forms a “vent,” which is an indentation line that extends partially into the glass surface. The vent functions as a separation line for controlled crack propagation of the glass sheet into two discrete pieces by applying mechanical force to the glass at the vent line. Glass LGPs up to 178 cm diagonal are currently available for use in displays having thicknesses in the range 0.5 mm and 2.5 mm. Perpendicularity of the edge of glass sheets is an attribute that can vary along the length of the glass sheet after breakage by as much at +/−8 degrees, meaning that instead of the edge having an angle of 90 degrees with respect to the major surfaces of the glass sheet from one end of the length to the other end of the length, there can be variation in angle between the edge and a major surface of the glass sheet between 82 degrees and 98 degrees. The perpendicularity can be improved by edge grinding and polishing processes, however, such processes require additional labor, time and processing equipment. Therefore, it would be desirable to provide apparatus and methods that can separate thin glass sheets having improved edge perpendicularity.

### SUMMARY

A first aspect of the disclosure pertains to an apparatus configured to separate a glass sheet having a first major surface and a second major surface defining a thickness therebetween in a range of 0.5 to 2.5 mm and having a vent line extending along a length of the glass sheet on the second major surface, the apparatus comprising a fulcrum configured to support the glass sheet on the first major surface and along the length of the glass sheet when the glass sheet is placed on upon the fulcrum; a vent bar comprising a first end and a second end defining a vent bar length therebetween and a contacting surface extending along the vent bar length, the vent bar contacting surface configured to apply a force on the second major surface of the glass sheet spaced apart from the vent line on a first side of the vent line and along the length of the vent line to cause the glass sheet to separate into two pieces along the vent line, the vent bar comprising a vent bar cushion along the vent bar length adjacent the vent bar contacting surface when the glass sheet is separated into two pieces along the vent line; and an elongate clamp bar comprising a clamp bar length and a clamp bar cushion configured to contact the glass sheet on a second side of the vent line opposite the first side of the vent line to apply a counteracting force when the vent bar contacting surface contacts the glass sheet.

A second aspect of the disclosure pertains to an apparatus configured to separate a glass sheet having a first major surface and a second major surface defining a thickness therebetween in a range of 0.5 to 2.5 mm and having a vent line extending along a length of the glass sheet on the second major surface, the apparatus comprising a fulcrum configured to support the glass sheet on the first major surface; a vent bar having a first end and a second end defining a vent bar length therebetween and positioned on a first side of the fulcrum and configured to exert a force on the second major surface of the glass sheet, the vent bar having a stiffness such that the vent bar bends when the vent bar exerts the force on the second major surface of the glass sheet to separate the glass sheet into two pieces; and a clamp bar positioned on second side of the fulcrum and configured to exert a force on the second major surface of the glass sheet, the vent bar having a vent bar cushion and the clamp bar comprising a clamp bar cushion.

Another aspect pertains to a method of breaking a glass sheet, the method comprising placing a glass sheet on a fulcrum, the glass sheet having a first major surface and a second major surface defining a thickness therebetween in a range of 0.5 to 2.5 mm and having a vent line extending along a length of the glass sheet on the second major surface; exerting a force on the second major surface of the glass sheet on a first side of the fulcrum with a vent bar contacting surface having a first end and a second end defining a vent bar length therebetween to separate the glass sheet into two pieces at the vent line; and exerting a force on the second major surface of the glass sheet with a clamp bar contact surface positioned on a second side of the fulcrum, wherein the vent bar contacting surface comprises a vent bar cushion material having a thickness and a hardness such that when the vent bar is pressed against the second major surface to separate the glass sheet into two pieces, the cushion material compresses a distance that reduces stress variation along the vent line compared with stress variation along the vent line when no cushion material is present on the vent bar.

Another aspect pertains to a method of breaking a glass sheet, the method comprising placing a glass sheet on a fulcrum, the glass sheet having a first major surface and a second major surface defining a thickness therebetween in a range of 0.5 to 2.5 mm and having a vent line extending along a length of the glass sheet on the second major surface; exerting a force on the second major surface of the glass sheet with a vent bar contacting surface positioned on a first side of the fulcrum to separate the glass sheet into two pieces, the vent bar having a first end and a second end defining a vent bar length therebetween; and exerting a force on the second major surface of the glass sheet with a clamp bar contact surface positioned on a second side of the fulcrum such that when the vent bar is pressed against the second major surface to separate the glass sheet into two pieces, the vent bar bends such that a force on the second major surface of the glass sheet adjacent the first end of the vent bar is different than a force on the second major surface of the glass sheet adjacent the second end of the vent bar resulting in a force variation between the first end and the second end, the method further comprising cushioning the vent bar contacting surface with a cushion material having a thickness and a hardness such that the cushion material compresses a distance such that the force variation between the first end and the second end is reduced compared to a process in which does not use a cushion material on the vent bar contacting surface.

### BRIEF DESCRIPTION OF THE DRAWINGS

The accompanying figures, which are incorporated in and constitute a part of this specification, illustrate several aspects described below.

FIG. 1 is a perspective view of an apparatus for separating a glass sheet according to an embodiment;

FIG. 2A is a side view of the apparatus shown in FIG. 1;

FIG. 2B is an end view of the apparatus of FIGS. 1 and 2A showing a vent bar without a cushion;

FIG. 3 is a side perspective view of an apparatus for separating a glass sheet according to an embodiment;

FIG. 4 is a perspective view of a portion of the apparatus shown in FIG. 3;

FIG. 5 is a perspective view a vent bar that can be used according to an embodiment;

FIG. 6 is a representation of a stress profile on a glass sheet being subjected to force from a vent bar and a clamp bar without a cushion on the vent bar or clamp bar;

FIG. 7 is a representation of a stress profile on a glass sheet being subjected to force from a vent bar and a clamp bar without a cushion on the vent bar or clamp bar;

FIG. 8 is graph showing data representing stress along a vent line for various modeling scenarios according to one or more embodiments;

FIG. 9 is a graph showing data representing vent bar bending for various scenarios according to one or more embodiments;

FIG. 10 illustrates an exemplary embodiment of a light guide plate; and

FIG. 11 illustrates total internal reflection of light at two adjacent edges of a glass LGP.

### DETAILED DESCRIPTION

Reference will now be made in detail to various embodiments, examples of which are illustrated in the accompanying examples and drawings.

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

Described herein are methods and apparatus for separating glass sheets. In specific embodiments, the glass sheets have excellent perpendicularity of an edge (“edge perpendicularity”) after separating with respect to a major surface of the glass sheet of 90°+/−3°, 90°+/−2.5°, 90°+/−2°, 90°+/−1.5°, 90°+/−1°, 90°+/−0.9°, 90°+/−0.8°, 90°+/−0.7°, 90°+/−0.7°, 90°+/−0.6°, 90°+/−0.5°, 90°+/−0.9°, 90°+/−0.3°, or 90°+/−0.2° along the entire length of an edge of a glass sheet that has been separated, without grinding or polishing the edge. In one or more embodiments, such excellent perpendicularity of 90°+/−3°, 90°+/−2.5°, 90°+/−2°, 90°+/−1.5°, 90°+/−1°, 90°+/−0.9°, 90°+/−0.8°, 90°+/−0.7°, 90°+/−0.7°, 90°+/−0.6°, 90°+/−0.5°, 90°+/−0.9°, 90°+/−0.3°, or 90°+/−0.2° along the entire length of an edge of a glass sheet that has been separated, without grinding or polishing the edge for glass sheets having a length of 0.5 m, 0.6 m, 0.7 m, 0.8 m, 0.9 m. 1 m, 1.5 m, 2 m, 2.1 m, 2.3, m, 2.4 m, and 2.5 m at the edge of separation, which occurs along the vent line. In one or more embodiments, the method and apparatus are configured to break a glass sheet resulting in a perpendicular edge with a perpendicularity variation of less than an absolute value of 2 degrees along an entire length of the edge or less than an absolute value of 0.5 degrees along an entire length of the edge. In specific embodiments, light guide plates are provided that have similar or superior optical properties to light guide plates made from PMMA and that have much better mechanical properties such as rigidity, coefficient of thermal expansion (CTE) and dimensional stability in high moisture conditions compared to PMMA light guide plates. As used herein, “separating” and “separation” refer to a breaking of a glass sheet into two pieces along a vent line.

Testing and modeling of glass separation processes revealed that improved edge perpendicularity can be achieved according to one or more embodiments by compensating for one or more factors that negatively impact edge perpendicularity. One factor that negatively impacts edge perpendicularity is misalignment of the apparatus that contacts the glass sheet during separation. Misalignment can result from one or more of several issues that can cause relative position of the elements that contact the glass sheet during separation (for example, the vent bar, the clamp bar, the fulcrum) with respect to a major surface of the glass. According to one or more embodiments, a vent bar is the element that applies mechanical force to the glass at the vent line that results in separation of the glass sheet along the vent line. Testing and modeling indicated that even a slight misalignment of the vent bar results in an uneven distribution of stress along the length of the vent line and negatively impacts edge perpendicularity. Misalignment can be a result of tolerance limits of the apparatus used to separate the glass, for example, flatness variation of the parts of the apparatus that contact the glass sheet during separation, such as the vent bar. These tolerance limits can also affect other separation elements (e.g., clamp bar or fulcrum) in a similar manner. A second factor that negatively impacts edge perpendicularity is bending of a separation element such as the vent bar, resulting in an uneven distribution of force by the vent bar and an uneven stress distribution along the length of the vent line. For example, a vent bar (or clamp bar or fulcrum) that has a relatively low stiffness will bend more during separation processes, which results in an uneven distribution of force on the glass along the length glass sheet, and an uneven stress distribution along the vent line during separation. Increasing stiffness and/or height of the vent bar reduces bending, reduces force variation on the glass sheet during separation and reduces stress variability along the length of the vent line. Bending due to insufficient stiffness of a separation element can similarly impact the fulcrum and/or the clamp bar. A third factor that that can result is uneven distribution of stress along the vent line during a separation process is inherent variability of the surface of the glass sheet. This factor may be referred to as glass shape error. A fourth factor that can result is uneven distribution of force on the glass sheet during separation and uneven distribution of stress along the vent line during a separation process is contamination, for example, particulate between a separation element (e.g., vent bar, clamp bar, fulcrum) and the glass sheet during separation. For example, dirt particles or glass shards can be present between a separation element and the glass sheet, which can result in uneven stress distribution along the length of the vent line. The effects of one or more of these factors, namely the uneven force distribution and stress along the length of the vent line, are addressed according to embodiments of the present disclosure. According to one or more embodiments, increasing stiffness of the vent bar or other separation elements that contact the glass sheet during separation (e.g., clamp bar or fulcrum) result in a more uniform stress along the length of the vent line compared with an apparatus or process using a less stiff separation element. In one or more embodiments, providing compliance in the form of cushioning at the interface of the separation elements (e.g., vent bar and clamp bar) can be used to compensate for machine misalignment, bending of the separation elements and/or contamination. According to one or more embodiments, compliance is provided by providing a cushion at the interface of the separation elements and the glass sheet. In one or more embodiments, the relative location of the separation elements, including the vent bar, clamps and bending fulcrum results a more uniform stress distribution along the vent line during separation of a glass sheet along the vent line, which in turn improves edge perpendicularity of the glass sheets.

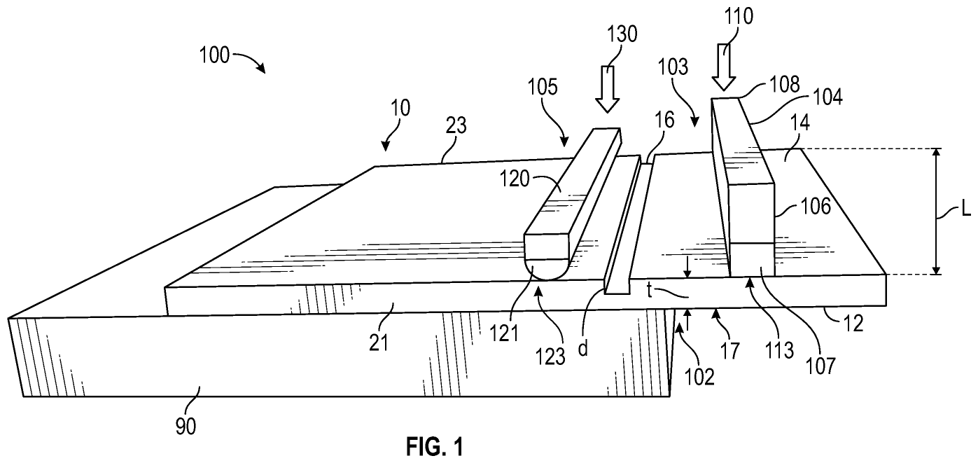

Referring now to FIGS. 1-4, an apparatus 100 configured to separate a glass sheet having a first major surface 12 and a second major surface 14 defining a thickness “t” therebetween and a vent line 16 extending along a length “L” of the glass sheet 10 on the second major surface 14 extending between glass sheet first end 21 and glass sheet second end 23. Thus the length L of the vent line 16 at least about 0.5 m, 0.6 m, 0.7 m, 0.8 m, 0.9 m. 1 m, 1.5 m, 2 m, 2.1 m, 2.3, m, 2.4 m, or 2.5 m between glass sheet first end 21 and glass sheet second end 23 (the width of the vent line is exaggerated for illustration purposes only). According to one or more embodiments, the thickness t of the glass sheet is in a range of about 0.3 mm to 3 mm, for example in a range of about 0.5 mm to 2.5 mm, and in particularly having a thickness t of about 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, or 2 mm. In one or more embodiments, the glass sheet is processed to provide a light guide plate discussed further below. In one or more embodiments, the vent line has a depth in a range of about 1% to 15% of the thickness of the glass sheet, for example in a range of about 2% to 12% of the thickness of the glass sheet, for example in a range of about 3% to 10% of the thickness of the glass sheet, for example in a range of about 4% to 8% of the thickness of the glass sheet, more particularly in a range of about 4% to 6% of the thickness of the glass sheet, and in specific embodiments about 5% of the thickness of the glass sheet.

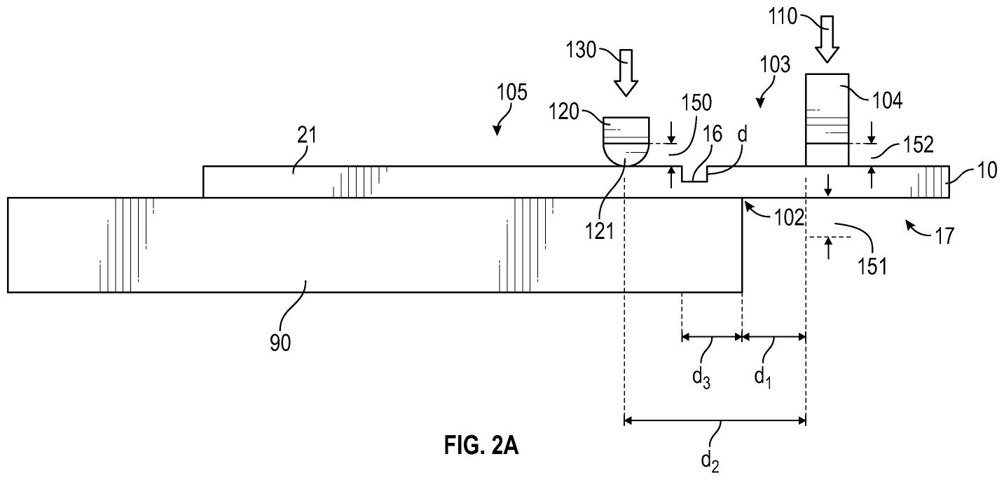

The apparatus 100 includes a fulcrum 102 configured to support the glass sheet 10 on the first major surface 12. The fulcrum can be in the form of an elongate support bar having a width in a range of about 0.1 cm-5 cm, or a table 90 which can support a substantial portion of the surface area a first major surface 12 of the glass sheet 10 as shown in FIGS. 1 and 2, with a breaking portion 17 extending past the fulcrum 102. According to one or more embodiments, a “substantial portion” of the first surface refers to greater than 50%, greater than 60%, greater than 70%, greater than 80% or greater than 90% of the surface area of the first surface. The glass sheet 10 has a length L, along which the vent line 16 extends between glass sheet first end 21 and glass sheet second end 23. The apparatus 100 further includes a vent bar 104 having a first end 106 and a second end 108 defining a vent bar length therebetween and positioned on a first side 103 of the fulcrum 102 and configured to exert a force (indicated by arrow 110) on the second major surface 14 of the glass sheet 10. Specifically referring to FIG. 2A, as is understood in the art, to achieve separation of the glass sheet into two pieces along the vent line 16, force is applied to the vent bar 104 while in contact with the second major surface 14 of the glass sheet 10, providing a stress along the vent line. In one or more embodiments, upon application of force to the vent bar 104, the portion of the glass sheet 10 in contact with the vent bar 104 is displaced in the direction of the force applied by the vent bar 104 by a distance referred to as “deflection distance” 151. The deflection distance 151 is the extent of travel of the first major surface 12 of the glass sheet from an initial position when the vent bar 104 initially contacts the second major surface 14 of the glass sheet 10 to a final position where a target stress at the vent line 16 is achieved to separate the glass sheet into two pieces. The extent of travel that defines the deflection distance 151 of the first major surface 12 of the glass sheet 10 is determined under the vent bar contacting surface 113 of the vent bar 104 on the first major surface 12 of the glass sheet 10. The target stress is a stress value at the vent line that will initiate and propagate a crack along the vent line 16 to cause separation of the glass sheet 10 into two pieces.

Referring to FIG. 2B, an end view of a table 90 holding a glass sheet to be separated in accordance with one or more embodiments is shown, illustrating misalignment of the apparatus and/or bending of a vent bar. FIG. 2B illustrates a vent bar 204 having a first end 206 and a second end 208 defining therebetween a length of the vent bar. The glass sheet 10, (which, as shown in FIGS. 1 and 2A) has the breaking portion 17 extending beyond the fulcrum 102. In one or more embodiments, the vent bar 204 has a length that is equal to or greater than the length “L” of the glass sheet. As shown in FIG. 2B, when the vent bar 104 has a force exerted upon the bar (the force represented by arrows 110), and a force is exerted upon the second major surface 14 of the glass sheet, misalignment in the apparatus and/or bending of the vent bar can cause vent bar 204 to be misaligned along the length of the vent bar 204 between first end 206 and second end 208, which can result in nonuniformity 111 (represented by arrow) along the length of the vent bar. The same principle can apply to the clamp bar and/or the fulcrum. Nonuniformity 111 refers to the difference in spacing between the vent bar and the second surface of the glass sheet at one portion or end of the vent bar, e.g., vent bar first end 206/glass sheet first end 21 and another portion or end of the vent bar, e.g., vent bar second end 208/glass sheet second end 23. As will be explained further below, this nonuniformity 111, which results from the difference in spacing between the vent bar and the second major surface 14 at glass sheet first end 21 and glass sheet second end 23 results in an uneven distribution of stress along the vent line of the glass sheet between glass sheet first end 21 and glass sheet second end 23. This uneven distribution of stress along the length of the vent line will result in a variation in perpendicularity of the edge formed at the vent line 16 when the glass sheet is broken. The variation in perpendicularity will be between glass sheet first end 21 and glass sheet second end 23. It is understood that FIG. 2B shows a case in which the nonuniformity 111 is greatest on first end 206 of the vent bar 204, however, this case illustrates just one example of variability that can occur during a separation process in which a glass sheet is broken into two pieces. The nonuniformity 111 may be greater on either end of the vent bar compared to the other end. Alternatively, the nonuniformity 111 may be greater between the first end 206 and second end 208 of the vent bar than at the ends of the bar, for example, in a case where the vent bar 204 bows upwardly in the middle due to insufficient stiffness. According to one or more embodiments, the vent bar has a stiffness sufficient to minimize bending of the vent bar and stress variation along the length of the vent line of the glass sheet when the glass sheet is separated into two pieces along the vent line, which will reduce nonuniformity 111. In one or more embodiments, the vent bar has a stiffness sufficient to substantially eliminate bending of the vent bar and minimize stress variation along the length of the vent line the glass sheet is separated into two pieces along the vent line, such that there is little to no variation in stress along the vent line during separation. According to one or more embodiments, “minimize stress variation” refers to a stress variation along the length of the vent line of less than less than 25% stress variation, less than 20% stress variation, less than 15% stress variation, less than 10% stress variation, or less than 5% stress variation.

Perpendicularity refers to an angle between first major surface 12 of the glass sheet and an edge of the glass sheet after separation. When the force applied by the vent bar 204 is uniform between first end 206 and second end 208 of the vent bar resulting in a uniform force distribution from glass sheet first end 21 to glass sheet second end 23, the angle between the edge and the first major surface after breaking the glass sheet 10 at the vent line will have very little or no variation, for example is 90°+/−2°, 90°+/−1°, or 90°+/−0.5° or less. However, modeling data discussed further below indicates that when there was no cushion between the vent bar 204 and the second major surface 14 of the glass sheet, there is a larger perpendicularity variation along the length L between glass sheet first end 21 and glass sheet second end 23, in some instances, 90°+/−8° along the length of the glass sheet.

According to one or more embodiments of the disclosure, the apparatus 100 shown in FIGS. 1, 2A, 3 and 4 further includes a clamp bar 120 positioned on second side 105 of the fulcrum 102 and configured to exert a force (indicated by arrow 130) on the second major surface 14 of the glass sheet 10. As shown in FIGS. 1 and 2A, the vent bar 104 has a vent bar cushion material 107 and the clamp bar 120 and has a clamp bar cushion 121. The vent bar cushion material 107 and the clamp bar cushion 121 are configured such that there is a combined displacement in a range of one to three times the nonuniformity 111 (represented by the arrow, shown in FIG. 2B), when the vent bar 104 exerts the force on the second major surface 14 of the glass sheet 10 to separate the glass sheet into two pieces. As used herein, the displacement of the clamp bar cushion 121 and the vent bar cushion material 107 refers to the distance each of the clamp bar cushion 121 and vent bar cushion material 107 compress when the force (indicated by arrow 130) is exerted on the clamp bar 120 and the force indicated by arrow 110 is exerted on the vent bar 104. This will be discussed further below.

In one or more embodiments, the vent bar 104 may be referred to an “elongate vent bar,” indicating the vent bar has a length that is at least equal to the length L of the glass sheet between glass sheet first end 21 and glass sheet second end 23 as discussed above. The vent bar 104 has a vent bar contacting surface 113 extending along the length of the vent bar 104. In one or more embodiments, the vent bar cushion material 107 provides the vent bar contacting surface 113, and, as shown in the drawings, the vent bar cushion material 107 touches the glass sheet. In one or more embodiments, the vent bar contacting surface 113 is configured to apply a force on the second major surface 14 of the glass sheet 10 spaced apart from the vent line 16 on a first side 103 of the vent line and along the length of the vent line to cause the glass sheet to separate into two pieces along the vent line. The clamp bar 120 may be referred to herein as “an elongate clamp bar,” and the clamp bar has a clamp bar cushion 121. The clamp bar 120 has a clamp bar contact surface 123 configured to contact or directly touch the glass sheet 10 at the second major surface 14 on a second side 105 of the vent line 16 opposite the first side 103 of the vent line 16 to apply a counteracting force when the vent bar contacts the glass sheet. The counteracting force counteracts the force applied by the vent bar 104 and holds the clamp bar 120 securely on the fulcrum 102 during a glass separating operation when the glass sheet 10 is broken along the vent line 16. The clamp bar contact surface 123 can be part of the clamp bar cushion 121, or alternatively, in an embodiment not shown, the clamp bar cushion 121 may be an intermediate member and a clamp bar cushion may provide the clamp bar contact surface 123 which touches the second major surface 14 of the glass sheet 10.

In one or more embodiments, the vent bar 104 (or elongate vent bar) has a stiffness configured to reduce bending of the vent bar 104, which will reduce stress variation along the length L of the vent line the when glass sheet 10 is separated into two pieces along the vent line 16. In one or more embodiments, a vent bar 104 having an increased stiffness will reduce bending of the vent bar 104, reduce nonuniformity and reduce stress variation along the length L_{B} of the vent line compared with an apparatus having a vent bar with a lower stiffness. Stiffness can be increased by using a material to form the vent bar that has a higher elastic modulus. Stiffness can also be increased by increasing height of the vent bar.

In one or more embodiments, the vent bar cushion material 107 and clamp bar cushion 121 each has a thickness and a Shore A hardness value (as measured by a durometer as provided by ASTM D2240) to provide a reduced stress variation along the length L of the vent line 16 between glass sheet first end 21 and glass sheet second end 23 during separation of the glass sheet into two pieces compared with the stress variation along the vent line obtained with a process or apparatus that utilizes a vent bar and/or a clamp bar without cushion. As shown further below, when no vent bar cushion is provided, there is a rather large stress variation along the vent line between glass sheet first end 21 and glass sheet second end 23 during separation of the glass sheet into two pieces using an elongate vent bar without a cushion and a clamp bar without a clamp bar cushion. In FIG. 2A, the clamp bar cushion 121 thickness is indicated as 150 and the vent bar cushion material 107 thickness is indicated as 152. In one or more embodiments, the vent bar cushion material thickness 152 is specifically designed such that stress variations along the vent line between glass sheet first end 21 and glass sheet second end 23 are substantially reduced compared to stress variation along the vent line obtained with a process or apparatus using a vent bar without a cushion. In one or more embodiments, the clamp bar cushion 121 thickness 150 also is specifically designed such that stress variations along the vent line between glass sheet first end 21 and glass sheet second end 23 are substantially reduced compared to stress variation along the vent line obtained with a process or apparatus using a clamp bar without a cushion.

In one or more embodiments, the vent bar cushion material 107 and the clamp bar cushion 121 each has a Shore A hardness in a range of 10 to 65, for example in a range of 10 to 65, for example in a range of 10 to 55, 10 to 50, 10 to 40, 10 to 35, 10 to 30, 10 to 25, 20 to 65, 20 to 55, 20 to 50, 20 to 45, 20 to 40, 20 to 35, 20 to 30, 30 to 65, 30 to 60, 30 to 55, 30 to 50, 30 to 45 or 30 to 40. In one or more embodiments, the vent bar cushion material 107 has a thickness 152 and clamp bar cushion 121 each has a thickness 152 in a range of 1 mm to 10 mm, for example, in a range of 5 mm to 10 mm. The cushion thickness can be in a range of 1-10 mm, 1-9 mm, 1-8 mm, 1-7 mm, 1-6 mm, 1-5 mm, 1-4 mm, 1-3 mm, 1-2 mm, 2-10 mm, 2-9 mm, 2-8 mm, 2-7 mm, 2-6 mm, 2-5 mm, 2-4 mm, 2-3 mm, 3-10 mm, 3-9 mm, 3-8 mm, 3-7 mm, 3-6 mm, 3-5 mm, 3-4 mm, 4-10 mm, 4-9 mm, 4-8 mm, 4-7 mm, 4-6 mm, 4-5, mm, 5-9 mm, 5-8 mm, 5-7 mm, 5-6 mm, 6-10 mm, 6-9 mm, 6-8 mm, 7-10 mm, or 7-9 mm. Finite element analysis modeling data and empirical data can be used to determine optimized vent bar cushion material thickness 152 values and Shore A hardness values as well as clamp bar cushion 121 thickness 150 values and Shore A hardness values in order to more evenly distribute stress along the vent line 16 during a glass separating operation.

In one or more embodiments, the vent bar cushion has a selected Shore A hardness such that the vent bar cushion material 107 is displaced a distance in a range equal to or greater than displacement of the glass sheet between opposite ends of the vent line between glass sheet first end 21 and glass sheet second end 23. In one or more embodiments, the clamp bar cushion 121 provides displacement such that stress along the vent line is more evenly distributed and stress variations between glass sheet first end 21 and glass sheet second end 23 are reduced compared with stress variation along the vent line between glass sheet first end 21 and glass sheet second end 23 obtained with a process or apparatus using a clamp bar without a cushion.

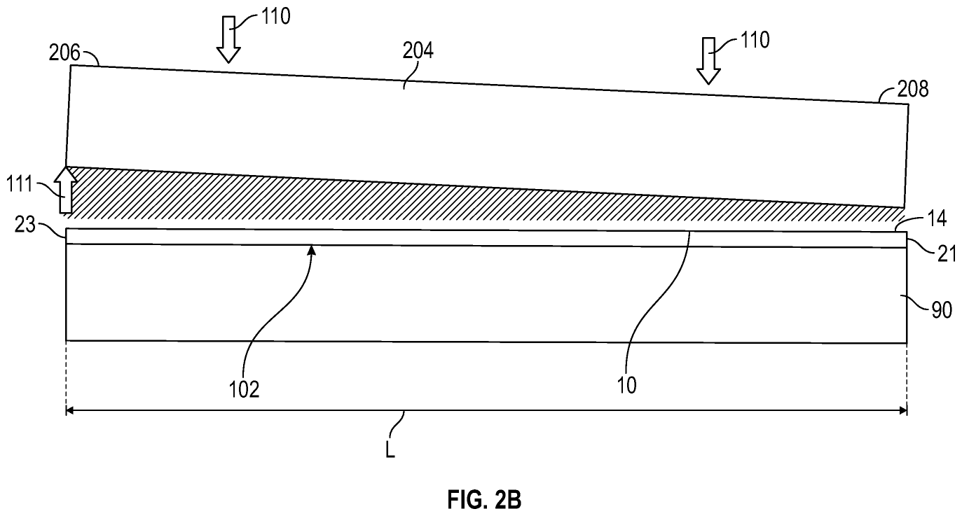

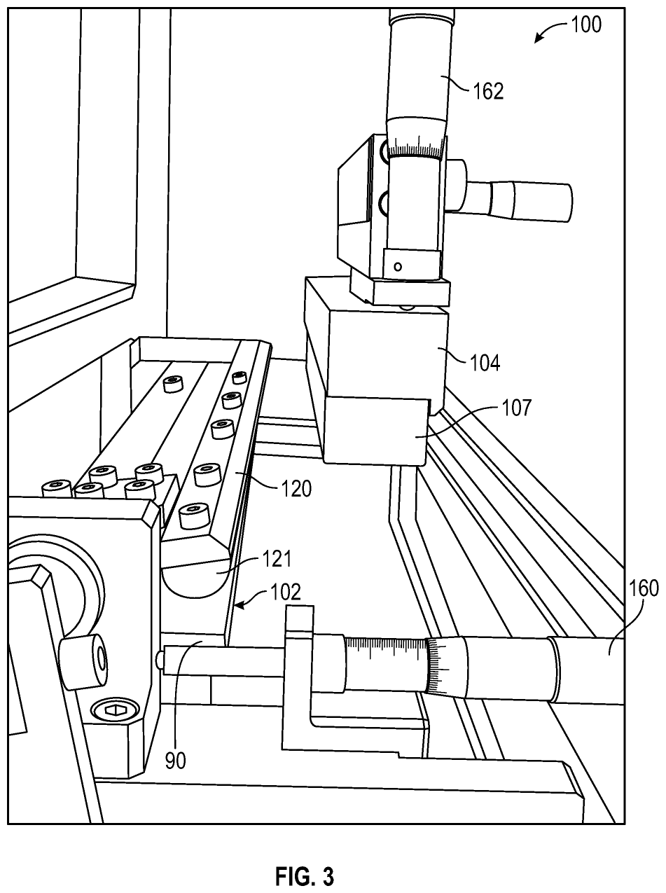

Referring now to FIGS. 3 and 4, an exemplary embodiment of an apparatus 100 including a fulcrum 102 in the form of a table to support a glass sheet (not shown), a vent bar 104 having a vent bar cushion material 107 and a clamp bar 120 having a clamp bar cushion 121 are shown. The apparatus can include a clamp bar position adjuster 160 and a vent bar position adjuster 162, which can adjust the positions of each of the vent bar 104 and the clamp bar 120. As shown in FIG. 4, the apparatus can be mounted on a frame 170, and a controller 180, motion of the vent bar 104 and clamp bar 120. The controller 180 is in communication with actuators (not shown) via a hardwired or wireless connection, which can actuate movement of the vent bar 104 and the clamp bar 120 to initiate a glass separation process according to one or more embodiments. The vent bar 104 and the clamp bar can be moved by hydraulic force, pneumatic force, a motor, or a servo motor according to one or more embodiments. The controller 180 can be any suitable component that can control movement of the vent bar 104 and the clamp bar 120. For example, the controller 180 can be a computer including a central processing unit, memory, suitable circuits and storage. The controller 180 can control other functions such as loading and unloading glass substrates that are to be separated according to one or more embodiments.

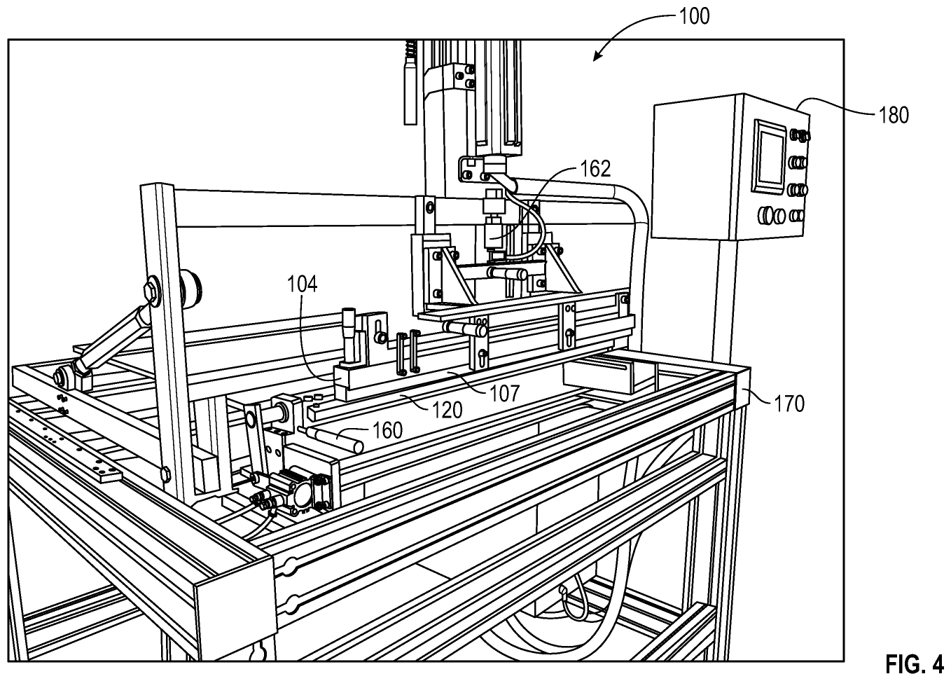

FIG. 5 shows an embodiment of a vent bar 104 having a length L_{B}, a height H_{B} and a width W_{B}, in which the stiffness was increase by increasing height dimension H_{B} of the vent bar. The vent bar 104 includes a plurality of cutouts 109 and reinforcing segments 117, the sizing and spacing of which can be utilized to provide the desired vent bar stiffness and weight. The stiffness of the bar can be increased by increasing the height H_{B} or using a material with a higher stiffness or elastic modulus.

Another aspect of the disclosure pertains to a method of breaking a glass sheet, the method comprising placing a glass sheet on a fulcrum, the glass sheet having a first major surface and a second major surface defining a thickness therebetween in a range of 0.5 to 2.5 mm and having a vent line extending along a length of the glass sheet on the second major surface, then exerting a force on the second major surface of the glass sheet with a vent bar contacting surface positioned on a first side of the fulcrum to separate the glass sheet into two pieces. The vent bar has a first end and a second end defining a vent bar length therebetween. The method further comprises exerting a force on the second major surface of the glass sheet with a clamp bar contact surface positioned on second side of the fulcrum, wherein the vent bar contacting surface is made from or comprises a cushion material having a thickness and a hardness such that when the vent bar is pressed against the second major surface to separate the glass sheet into two pieces, the cushion material compresses a distance that reduces stress variation along the vent line. As discussed further herein, a vent bar without a cushion has a large stress variation along the length of the vent line. In specific method embodiments, the clamp bar has a clamp bar cushion. In one or more embodiments, the vent bar cushion material and the clamp bar cushion each has a Shore A hardness in a range of 10 to 65, for example in a range of 10 to 55, 10 to 50, 10 to 40, 10 to 35, 10 to 30, 10 to 25, 20 to 65, 20 to 55, 20 to 50, 20 to 45, 20 to 40, 20 to 35, 20 to 30, 30 to 65, 30 to 60, 30 to 55, 30 to 50, 30 to 45 or 30 to 40. In one or more embodiments of the method, the vent bar cushion and clamp bar cushion each has a thickness in a range of 1 mm to 10 mm, for example in a range of 5 mm to 10 mm. The cushion thickness can be in a range of 1-10 mm, 1-9 mm, 1-8 mm, 1-7 mm, 1-6 mm, 1-5 mm, 1-4 mm, 1-3 mm, 1-2 mm, 2-10 mm, 2-9 mm, 2-8 mm, 2-7 mm, 2-6 mm, 2-5 mm, 2-4 mm, 2-3 mm, 3-10 mm, 3-9 mm, 3-8 mm, 3-7 mm, 3-6 mm, 3-5 mm, 3-4 mm, 4-10 mm, 4-9 mm, 4-8 mm, 4-7 mm, 4-6 mm, 4-5, mm, 5-9 mm, 5-8 mm, 5-7 mm, 5-6 mm, 6-10 mm, 6-9 mm, 6-8 mm, 7-10 mm, or 7-9 mm.

Another aspect of the disclosure pertains to a method of breaking a glass sheet, the method comprising placing a glass sheet on a fulcrum, the glass sheet having a first major surface and a second major surface defining a thickness therebetween in a range of 0.5 to 2.5 mm and having a vent line extending along a length of the glass sheet on the second major surface. The method includes exerting a force on the second major surface of the glass sheet on a first side of the fulcrum with a vent bar having a vent bar contacting surface to separate the glass sheet into two pieces at the vent line. The vent bar has a first end and a second end defining a vent bar length therebetween. The method further comprises exerting a force on the second major surface of the glass sheet with a clamp bar contact surface positioned on second side of the fulcrum, such that when the vent bar is pressed against the second major surface to separate the glass sheet into two pieces, the vent bar bends such that a force on the second major surface of the glass sheet adjacent the first end of the vent bar is different than a force on the second major surface of the glass sheet adjacent the second end of the vent bar resulting in a force variation between the first end and the second end. The method further comprises cushioning the vent bar contacting surface with a cushion material having a thickness and a hardness such that the cushion material compresses a distance such that the stress variation between the first end and the second end is reduced compared to stress variation between the first end and the second end obtained with a process or apparatus using a vent bar without a cushion. In one or more embodiments, the vent bar cushion material and the clamp bar cushion material each has a Shore A hardness in a range of 10 to 65, for example in a range of 10 to 55, 10 to 50, 10 to 40, 10 to 35, 10 to 30, 10 to 25, 20 to 65, 20 to 55, 20 to 50, 20 to 45, 20 to 40, 20 to 35, 20 to 30, 30 to 65, 30 to 60, 30 to 55, 30 to 50, 30 to 45 or 30 to 40. In one or more embodiments of the method the vent bar cushion and clamp bar cushion each has a thickness in a range of 1 mm to 10 mm, for example in a range of 5 mm to 10 mm. The cushion thickness can be in a range of 1-10 mm, 1-9 mm, 1-8 mm, 1-7 mm, 1-6 mm, 1-5 mm, 1-4 mm, 1-3 mm, 1-2 mm, 2-10 mm, 2-9 mm, 2-8 mm, 2-7 mm, 2-6 mm, 2-5 mm, 2-4 mm, 2-3 mm, 3-10 mm, 3-9 mm, 3-8 mm, 3-7 mm, 3-6 mm, 3-5 mm, 3-4 mm, 4-10 mm, 4-9 mm, 4-8 mm, 4-7 mm, 4-6 mm, 4-5, mm, 5-9 mm, 5-8 mm, 5-7 mm, 5-6 mm, 6-10 mm, 6-9 mm, 6-8 mm, 7-10 mm, or 7-9 mm.

Modeling data obtained by finite element analysis was utilized to illustrate principles according one or more embodiments of the disclosure. Through modeling it was determined that adjusting the stiffness of the vent bar and/or clamp bar, and in some embodiments, adding vent bar cushion to the vent bar and/or a clamp bar cushion reduced stress variation along the length of the vent line and improved perpendicularity of the edge produced at the vent line compared to stress variation along the length of the vent line obtained with a process or apparatus with a vent bar or clamp bar with lower stiffness and/or a vent bar and/or clamp bar without a cushion. In one or more embodiments, perpendicularity was determined to be 90°+/−3°, 90°+/−2.5°, 90°+/−2°, 90°+/−1.5°, 90°+/−1°, 90°+/−0.9°, 90°+/−0.8°, 90°+/−0.7°, 90°+/−0.7°, 90°+/−0.6°, 90°+/−0.5°, 90°+/−0.9°, 90°+/−0.3°, or 90°+/−0.2° along the entire length of an edge of a glass sheet that has been separated at the vent line as separated, without grinding or polishing the edge. It was determined that providing a vent bar cushion, and in some embodiments, a clamp bar cushion, compensates for apparatus misalignment and to creates a uniform pre-load stress prior to crack initiation along the vent line. Modeling data also indicated that increasing the vent bar stiffness and clamp bar stiffness, as well as providing a vent bar cushion and clamp bar cushion according to one or more embodiments improved edge perpendicularity and reduce yield losses due to edge quality defects that occur when the stress along the vent line varies. Modeling also indicated that adding a cushion to an insufficiently stiff vent bar and/or clamp bar resulted little to no significant improvement of providing uniform stress along the vent line. Modeling also indicated that a higher vent bar stiffness and a moderate amount of compliance provided by a cushion, for example, 10 mm of 30 Shore A hardness (as measured by a durometer as provided by ASTM D2240) cushion material, significantly reduces the stress variation along the length of the vent line created by misalignment and insufficient stiffness of the vent bar and/or clamp bar compared with a vent bar having lower stiffness and no cushion.

Thus, according to one or more embodiments of the disclosure, increasing at least one of the vent bar and clamp bar stiffness ensures application of more uniform stress along the entire length L of the vent line without the vent bar deforming greater than 0.1 mm across the length of the vent bar. In one or more embodiments, cushion material on the vent bar at the interface with the glass sheet and/or cushion material on the clamp bar at the interface with the glass sheet compensate for one or more of bending, machine alignment error and glass shape error. Suitable, non-limiting examples of cushion materials include silicones, polyurethanes, and natural rubber materials.

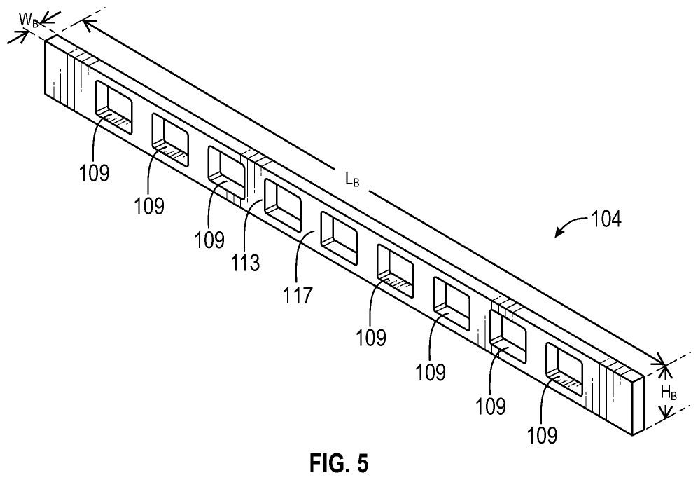

Modeling indicated that a cushion material having the Shore A hardness value ranges indicated herein provides a compliant material that reduces requirements for precision machine tolerance by absorbing slight misalignments in the machine elements that contact the glass such and producing a more uniform pre-load stress. For the modeling experiments and the data shown in FIGS. 6-9, a target tensile stress of about 20 MPa was selected as a target for crack initiation and propagation. The actual tensile stress of the target for crack initiation can be determined by experimentation and can depend on vent depth and glass composition. In one or more embodiments, a crack should be initiated at one end of the sheet and propagate to other end. With reference to FIG. 2A, the distance d3 of the vent line 16 to the fulcrum 102, the distance d1 of the clamp bar 120 to the fulcrum 102 and the distance d2 from the vent bar 104 to the fulcrum should be in the following ranges:

d1=10 mm to 150 mm
d2=10 mm to 300 mm
d3=−2 mm to 5 mm.

In one or more embodiments, the distance from the clamp bar to the vent line should be approximately equal to the distance between the vent line and the vent bar so that d2 should accommodate this by being two times d1.

In the modeling data discussed below with respect to FIGS. 6-9, a total nonuniformity resulting from bending and alignment is less than the deflection distance of the glass when achieving a 20 MPa target stress at the vent line. A vent bar and clamping bar cushion hardness range of about 10-65 Shore A at a cushion thickness of in a range of 1-10 mm was determined to achieve compression that is two to three times the bending/surface finish/alignment variation distance between the vent bar and the second major surface of the glass sheet. Finite element modeling herein was based on targets arrived at by calculation and vent bar stiffness, clamp bar stiffness, cushion thickness and cushion hardness and glass deflection as achieved by constraint conditions d1 and d2.

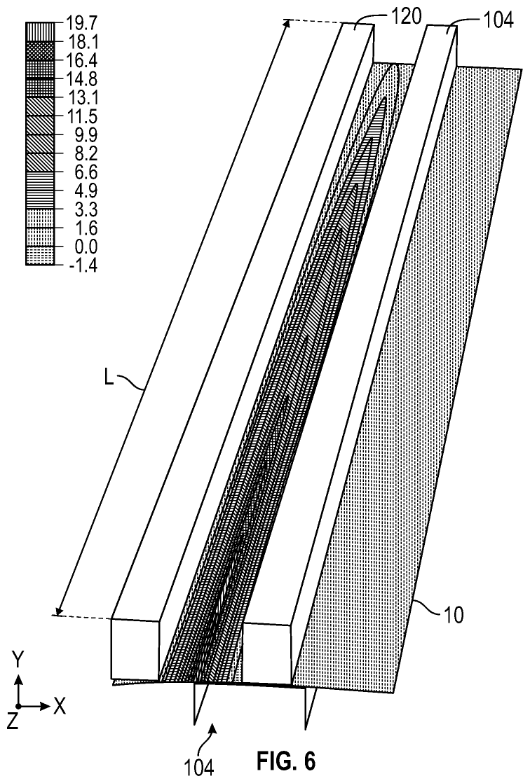

In FIGS. 6 through 9, the impact a 30 Shore A cushion on the clamp bar and the vent bar, at 5 and 10 mm thicknesses on the vent bar when the vent bar has 0.090 mm of misalignment. As a general principle for the modeling data, a combination of nonuniformity due to vent bar bending and apparatus alignment variation should be less than the deflection of the glass when the vent line has an applied target stress of about 20 MPa. In FIGS. 6 through 8, the modeling data is based on nonuniformity of 0.090 mm due to apparatus misalignment and about 0.1 mm of glass deflection when the vent line experiences a force of about 20 MPa. Modeling indicated that cushion displacement should be in a range of about one to three times of the nonuniformity due to both the vent bar bending and/or misalignment (as illustrated in FIG. 2B) to accommodate the compression of the cushion into force variability along the vent bar surface, which reduces stress variability along the vent line compared to a process or apparatus that does not use a cushion on the vent bar. In the modeling examples in FIGS. 6 through 9, the cushion displaces an average of 0.120 to 0.230 depending on the cushion thickness compared to the glass displacement of 0.1 mm. FIG. 6 shows a model of a vent bar with 0.090 mm of nonuniformity due to tilt with no cushion on the vent bar 104 or the clamp bar 120. As can be seen by the stress distribution with reference to the legend, the stress is uneven along the length L of the glass sheet 10. FIG. 7 shows a vent bar 104 with a vent bar cushion material 107 and a clamp bar 120 with a clamp bar cushion 121, both 10 mm thick and 30 Shore A hardness. The stress profile along the length L of the glass sheet 10 is more uniform along the length L compared to FIG. 6.

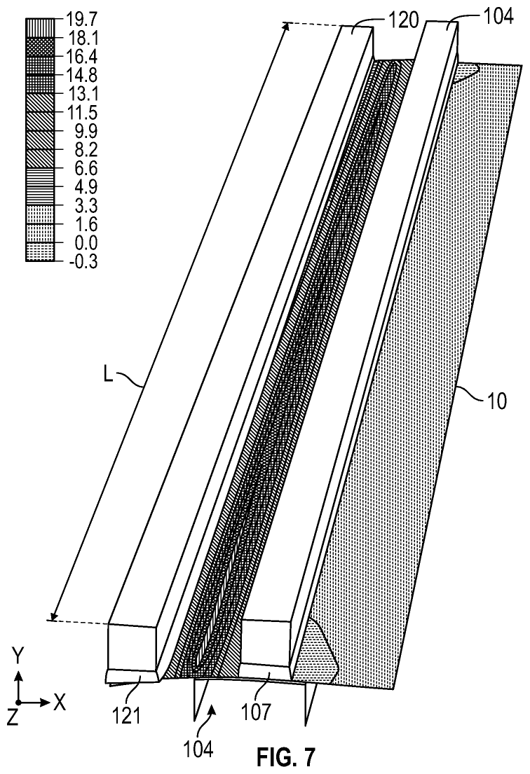

FIG. 8 shows modeling data for various cases. The Baseline indicates ideal conditions of the 20 MPa target stress along the length of the glass at the vent line during separation. The 0.15 theta z indicates vent bar nonuniformity due to tilt of 0.15 mm, and the stress along the vent line is uneven, similar to the plot for 0.09 mm theta z, representing 0.09 mm of tilt, both showing high stress variability along the length of the glass sheet. As indicated in FIG. 8, 0.09 mm of tilt with 5 mm of 30 Shore A cushion improved the stress variability along the vent line, 0.03 mm of tilt with 5 mm of 30 Shore A cushion improved the stress variability along the length of the glass sheet, with better results for 0.09 mm of tilt with a 10 mm thick 30 Shore A cushion and the lowest variability for 0.03 mm of tilt with a 10 mm thick cushion having 30 Shore A hardness. Thus, it is shown that a cushion on the vent bar, and in some embodiments on the clamp bar can greatly improve variability in stress along the vent line of a glass sheet being subject to separation by application of force on a side of the substrate having a vent line and supported on an opposite side by a fulcrum.

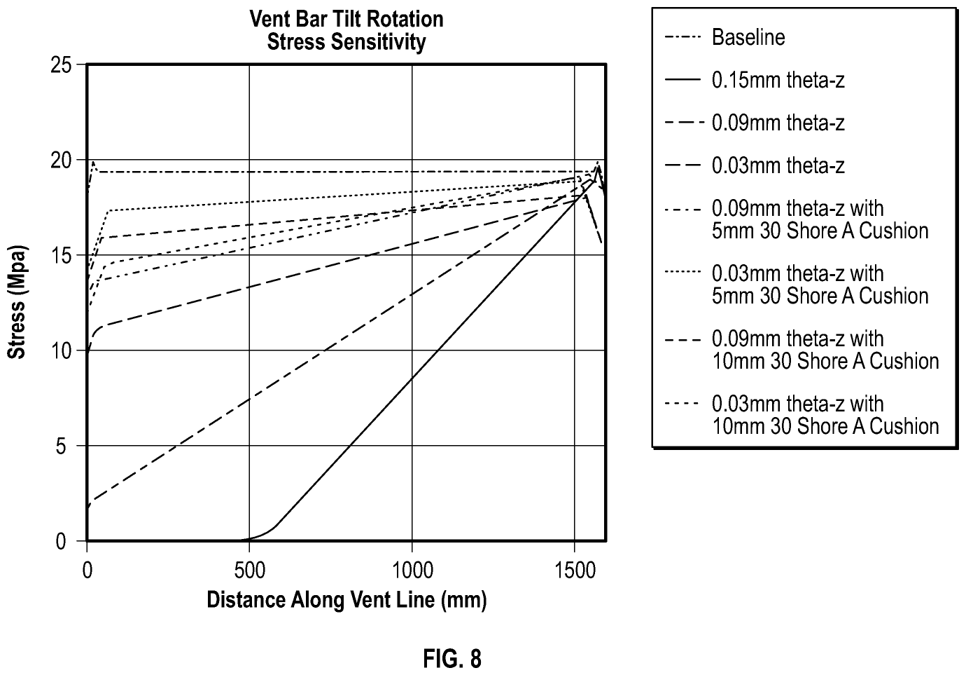

Referring to FIG. 9, various configurations were modeled to predict vent bar deflection (or bending) under 850 N load and 2500 N load using a range of clamp and vent bar positions. The modeling data in FIG. 9 is based on a bar with no tilt, and the data takes into account bending of the bar only. In FIG. 9, case one is for a bar having low stiffness, and a bar having width/height/length dimensions of 40 mm×40 mm×2030 mm; Case 2 is for a low stiffness bar having width/height/length dimensions of 40 mm×40 mm×1860 mm; Case 3 is for a low stiffness bar having width/height/length dimensions of 40 mm×80 mm×1860 mm; Case 4 is for a high stiffness bar similar to the one shown in FIG. 5 having a length of 1860 mm; and Case 5 is for a high stiffness bar similar to the one shown in FIG. 5 having a length of 2330 mm. Cases 1-3 were low stiffness vent bars and had the highest vent bar deflections due to bending as a result of their low stiffness. Case 1, which had similar height and width dimensions compared with Case 2, had higher deflection due to bending because the bar was longer. Case 3, which increased the height of the vent bar compared to case 2, had improved stiffness and lower deflection due to bending. Cases 4 and 5, which used high stiffness vent bars had lower deflection due to bending, with Case 5 having a higher deflection due to than Case 4 due to the longer length of the Case 5 vent bar.

In one or more embodiments of the methods and apparatus described herein, the glass sheet is a light guide plate, the finished edge is a light injection edge that scatters light within an angle less than 12.8 degrees full width half maximum (FWHM) in transmission. In one or more embodiments of the method wherein the glass sheet is a light guide plate, the finished edge has a light transmission at least 95% at a wavelength of 450 nm.

In one or more embodiments of the method, the glass sheet is a light guide plate and the light guide plate comprises SiO₂ in a range of 50 mol % to 80 mol %, Al₂O₃ in a range of 0 mol % to 20 mol %, and B₂O₃ in a range of 0 mol % to 25 mol %, and less than 50 ppm by weight iron (Fe) concentration.

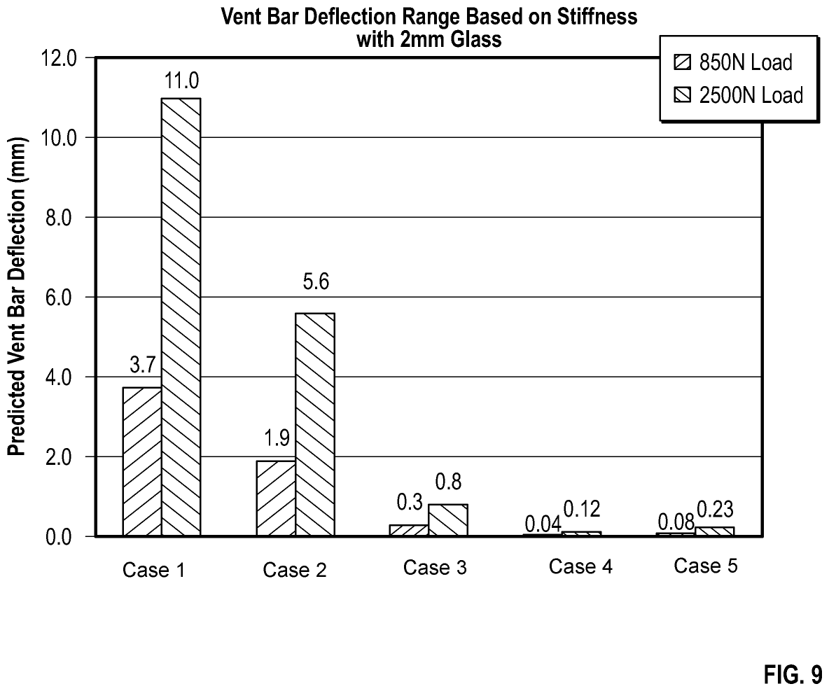

FIG. 10 illustrates an exemplary embodiment of a light guide plate that can be made by the methods and apparatus of the present disclosure with the shape and structure of a typical light guide plate comprising a glass sheet having a first face 610, which may be a front face, and a second face opposite the first face, which may be a back face. The first and second faces have a height, H, and a width, W. In one or more embodiments, the first and/or second face(s) have an average roughness (Rₐ) that is less than 0.6 nm.

The glass sheet 600 has a thickness, T, between the front face and the back face, wherein the thickness forms four edges. The thickness of the glass sheet is typically less than the height and width of the front and back faces. In various embodiments, the thickness of the light guide plate is less than 1.5% of the height of the front and/or back face. In one or more embodiments, the thickness, T, may be about 3 mm, about 2.5 mm, about 2 mm, about 1.9 mm, about 1.8 mm, about 1.7 mm, about 1.6 mm, about 1.5 mm, about 1.4 mm, about 1.3 mm, about 1.2 mm, about 1.1 mm, about 1 mm, about 0.9 mm, about 0.8 mm, about 0.7 mm, about 0.6 mm, about 0.5 mm, about 0.4 mm or about 0.3 mm. The height, width, and thickness of the light guide plate are configured and dimensioned for use as a LGP in an LCD backlight application as described above.

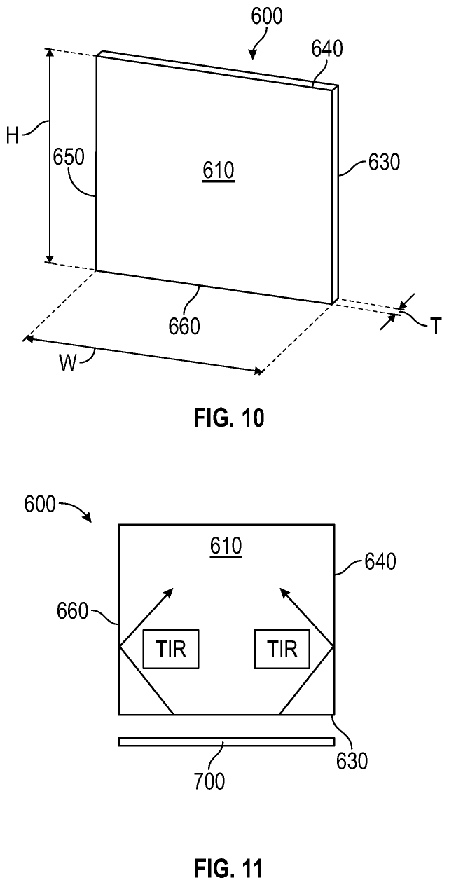

Referring to FIG. 11, a first edge 630 is a light injection edge that receives light provided for example by a light emitting diode (LED). In some embodiments, the light injection edge scatters light within an angle less than 12.8 degrees full width half maximum (FWHM) in transmission. The light injection edge can be obtained by grinding and polishing the first edge 630.

The glass sheet furthers comprise a second edge 640 adjacent to the first edge 630 and a third edge 660 opposite the second edge 640 and adjacent to the first edge 630, where the second edge 640 and/or the third edge 660 scatter light within an angle of less than 12.8 degrees FWHM in reflection. The second edge 640 and/or the third edge 660 may have a diffusion angle in reflection that is less 6.4 degrees. The glass sheet includes a fourth edge 650 opposite the first edge 630.

According to one or more embodiments, three of the four edges of the LGP have a mirror polished surface for two reasons, LED coupling and total internal reflection (TIR at two edges. According to one or more embodiments, and as illustrated in FIG. 11, light injected into a first edge 630 can be incident on a second edge 640 adjacent to the injection edge and a third edge 660 adjacent to the injection edge, wherein the second edge 640 is opposite the third edge 660. The second and third edges may also have a low average roughness at the edge of less than 0.5 μm, 0.4 μm, 0.3 μm or 0.2 μm without etching with hydrofluoric acid and/or slurry polishing the edge so that the incident light undergoes total internal reflectance (TIR) from the two edges adjacent the first edge.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary. It will be apparent to those skilled in the art that various modifications and variations can be made without departing from the spirit or scope of the disclosure.

What is claimed is:

1. An apparatus configured to separate a glass sheet having a first major surface and a second major surface defining a thickness therebetween in a range of 0.5 to 2.5 mm and having a vent line extending along a length of the glass sheet on the second major surface, the apparatus comprising:
a fulcrum configured to support the glass sheet on the first major surface and along the length of the glass sheet when the glass sheet is placed on upon the fulcrum;
a vent bar comprising a first end and a second end defining a vent bar length therebetween and a contacting surface extending along the vent bar length, the vent bar contacting surface configured to apply a force on the second major surface of the glass sheet spaced apart from the vent line on a first side of the vent line and along the length of the vent line to cause the glass sheet to separate into two pieces along the vent line, the vent bar comprising a vent bar cushion along the vent bar length adjacent the vent bar contacting surface when the glass sheet is separated into two pieces along the vent line; and
an elongate clamp bar comprising a clamp bar length and a clamp bar cushion configured to contact the glass sheet on a second side of the vent line opposite the first side of the vent line to apply a counteracting force when the vent bar contacting surface contacts the glass sheet.

2. The apparatus of claim 1, wherein the vent bar has a stiffness sufficient to minimize bending of the vent bar and minimize stress variation along the length of the vent line of the glass sheet when the glass sheet is separated into two pieces along the vent line.

3. The apparatus of claim 1, wherein the vent bar cushion and clamp bar cushion each has a thickness and a Shore A hardness value that provides a reduced stress variation along the vent line during separation of the glass sheet into two pieces compared to a stress variation along the vent line during separation of the glass sheet into two pieces using a vent bar without a cushion and a clamp bar without a clamp bar cushion.

4. The apparatus of claim 1, wherein the vent bar cushion and the clamp bar cushion each has a Shore A hardness value in a range of 10 to 65.

5. The apparatus of claim 4, wherein the vent bar cushion and clamp bar cushion each has a thickness in a range of 1 mm to 10 mm.

6. The apparatus of claim 5 wherein the vent bar cushion and clamp bar cushion each has a thickness in a range of 5 mm to 10 mm.

7. The apparatus of claim 6, wherein the vent bar cushion and the clamp bar cushion each has a Shore A hardness in a range of 20 to 35.

8. The apparatus of claim 1, wherein the vent bar cushion and the clamp bar cushion have a hardness value such that the vent bar cushion is displaced a distance in a range equal to or greater than a displacement of the glass sheet between opposite ends of the vent line.

9. The apparatus of claim 1, wherein the apparatus is configured to break a glass sheet resulting in a perpendicular edge with a perpendicularity variation of less than an absolute value of 2 degrees along an entire length of the edge.

10. The apparatus of claim 1, wherein the apparatus is configured to break a glass sheet resulting in a perpendicular edge with a perpendicularity variation of less than an absolute value of 0.5 degrees along an entire length of the edge.

11. An apparatus configured to separate a glass sheet having a first major surface and a second major surface defining a thickness therebetween in a range of 0.5 to 2.5 mm and having a vent line extending along a length of the glass sheet on the second major surface, the apparatus comprising:
a fulcrum configured to support the glass sheet on the first major surface;
a vent bar having a first end and a second end defining a vent bar length therebetween and positioned on a first side of the fulcrum and configured to exert a force on the second major surface of the glass sheet to separate the glass sheet into two pieces; and
a clamp bar positioned on second side of the fulcrum and configured to exert a force on the second major surface of the glass sheet, the vent bar having a vent bar cushion and the clamp bar comprising a clamp bar cushion.

12. The apparatus of claim 11, wherein the vent bar cushion and the clamp bar cushion each has a Shore A hardness in a range of 10 to 65.

13. The apparatus of claim 12, wherein the vent bar cushion and clamp bar cushion each has a thickness in a range of 1 mm to 10 mm.

14. The apparatus of claim 13 wherein the vent bar cushion and clamp bar cushion each has a thickness in a range of 5 mm to 10 mm.

15. The apparatus of claim 14, wherein the vent bar cushion and the clamp bar cushion each has a Shore A hardness in a range of 20 to 35.

16. A method of breaking a glass sheet, the method comprising:
placing a glass sheet on a fulcrum, the glass sheet having a first major surface and a second major surface defining a thickness therebetween in a range of 0.5 to 2.5 mm and having a vent line extending along a length of the glass sheet on the second major surface;
exerting a force on the second major surface of the glass sheet on a first side of the fulcrum with a vent bar contacting surface having a first end and a second end defining a vent bar length therebetween to separate the glass sheet into two pieces at the vent line; and
exerting a force on the second major surface of the glass sheet with a clamp bar contact surface positioned on a second side of the fulcrum, wherein the vent bar contacting surface comprises a vent bar cushion material having a thickness and a hardness such that when the vent bar is pressed against the second major surface to separate the glass sheet into two pieces, the vent bar cushion material compresses a distance that reduces stress variation along the vent line compared with stress variation along the vent line when no cushion material is present on the vent bar.

17. The method of claim 16, wherein the clamp bar comprises a clamp bar cushion which provides the clamp bar contact surface.

18. The method of claim 17, wherein the vent bar cushion material and the clamp bar cushion each has a Shore A hardness in a range of 10 to 65.

19. The method of claim 18, wherein the vent bar cushion material and clamp bar cushion each has a thickness in a range of 1 mm to 10 mm.

20. The method of claim 19, wherein the vent bar cushion material and clamp bar cushion each has a thickness in a range of 5 mm to 10 mm.

21. The method of claim 19, wherein the vent bar cushion material and the clamp bar cushion each has a Shore A hardness in a range of 20 to 35.

22. A method of breaking a glass sheet, the method comprising:
placing a glass sheet on a fulcrum, the glass sheet having a first major surface and a second major surface defining a thickness therebetween in a range of 0.5 to 2.5 mm and having a vent line extending along a length of the glass sheet on the second major surface;
exerting a force on the second major surface of the glass sheet with a vent bar contacting surface positioned on a first side of the fulcrum to separate the glass sheet into two pieces, the vent bar having a first end and a second end defining a vent bar length therebetween; and
exerting a force on the second major surface of the glass sheet with a clamp bar contact surface positioned on a second side of the fulcrum such that when the vent bar is pressed against the second major surface to separate the glass sheet into two pieces, the vent bar bends such that a force on the second major surface of the glass sheet adjacent the first end of the vent bar is different than a force on the second major surface of the glass sheet adjacent the second end of the vent bar resulting in a force variation between the first end and the second end, the method further comprising cushioning the vent bar contacting surface with a cushion material having a thickness and a hardness such that the cushion material compresses a distance such that the force variation between the first end and the second end is reduced compared to a process in which does not use a cushion material on the vent bar contacting surface.

23. The method of claim 22, wherein the clamp bar comprises a clamp bar cushion.

24. The method of claim 23, wherein the cushion material and the clamp bar cushion each has a Shore A hardness in a range of 10 to 65.

25. The method of claim 24, wherein the cushion material and clamp bar cushion each has a thickness in a range of 1 mm to 10 mm.

26. The method of claim 25, wherein the cushion material and clamp bar cushion each has a thickness in a range of 5 mm to 10 mm.

27. The method of claim 26, wherein the cushion material and the clamp bar cushion each has a Shore A hardness in a range of 20 to 35.
